(19) United States
(12) Patent Application Publication
(10) Pub. No.: US 2014/0129963 A1
(43) Pub. Date: May 8, 2014

(54) System, Method and Computer Program for Receiving and Publishing Details of Sporting Events in Real-Time

(71) Applicant: Real-Time Sports, Inc., White Plains, NY (US)

(72) Inventors: Richard Portale, White Plains, NY (US); Gregory Stelluti, Wyomissing, PA (US)

(73) Assignee: REAL-TIME SPORTS, INC., White Plains, NY (US)

(21) Appl. No.: 14/074,673

(22) Filed: Nov. 7, 2013

Related U.S. Application Data
(60) Provisional application No. 61/723,985, filed on Nov. 8, 2012.

(51) Int. Cl. H04L 29/06

(52) U.S. Cl. CPC H04L 65/403
USPC 715/753

(57) ABSTRACT

A system, method and computer program for publishing details of sporting events, in real-time, e.g., during the event, is presented. For instance, at least one embodiment includes receiving event data in real-time during the course of the sporting event, wherein the event data is received from an input device operated by an authorized user. In certain embodiments, the authorized user may include an official or referee of the event, a designated score keeper, and/or a designated and registered administrative user associated with one of the participating teams. Further, the invention includes processing a request to receive event data, in that the various users may choose to subscribe to certain teams and/or events. Accordingly, the event data is then published to the subscribed users, for example, via a push notification, scrolling scoreboard, or dynamically updated scorecard.

### CROSS REFERENCE TO RELATED APPLICATIONS/CLAIM OF PRIORITY

The present application is based on and a claim to priority is made under 35 U.S.C. §119(e) to currently pending provisional patent application Ser. No. 61/723,985, having a filing date of Nov. 8, 2012, the content of which is incorporated herein its entirety.

### FIELD OF THE INVENTION

The present invention is generally directed to a system, method and computer program for receiving and publishing details of sporting events in real-time, for example, during the course of the event. In certain embodiments, a game official, referee, score keeper or administrative user associated with a team may input event details, such as scoring events, player misconduct, substitutions, etc., during the course of the event. Other users who have subscribed to a participating team or the event will receive the event details in real-time, for example, via a scrolling scoreboard, push or other notifications, or a dynamic scorecard accessed via the user's profile or account.

### BACKGROUND OF THE INVENTION

Sports and other like events are inherently mobile in that they generally occur on fields, in gymnasiums, at parks and at stadium. Particularly, fans, family members, players, coaches, and other people are oftentimes passionate about sports and desire up-to-date information in real-time as the sport or other event progresses, particularly for sports and events that are not reported via the news, online, television, radio, etc. or are otherwise under reported such that information and/or details pertaining thereto is generally difficult to obtain.

Today's standard operating procedure for non-judge type sports, for example, required a match or event official to wear a stop watch and carry a pencil (or other writing instrument) along with a hand held piece of paper or laminated plastic scorecard in his or her sock, pocket or on his or her arm to record the event details and data during the course of the match or event. Oftentimes, the card will get smudged in the rain, snow, or by sweat. The pencil tip may break requiring some officials to also carry a pencil sharpener.

Given the above archaic recording method, the data is oftentimes not reported or published in a timely fashion. Currently, if one wishes to follow the match scoring in real-time, one must actively watch the game or periodically check into a web-based publication service, which may also publish inaccurate information.

Moreover, referees or officials may report the event details to a governing body after the conclusion of the game or match. Following the game, the official typically fills out a form and faxes or emails the form to the governing body. Officials at the governing body and/or press facility take the faxed forms off of the fax machine and manually key in the official stats that only become available to the public may days later. In some cases, an online form may be uploaded to a web-based platform that can then be accessed via the Internet by users desiring to know the scores.

Furthermore, in under reported or unreported events, such as little league, club sports, peewee leagues, etc., oftentimes the family members and friends of those involved would like to follow the game in real-time but are unable to attend.

Accordingly, there is a need in the art for a system, method and computer program that can publish or communicate event details to subscribed users in real-time. The data or event details may be generated by the official, referee, designated score keeper, an administrative user, or any other authorized user of the system and communicated in real-time, during the course of the event of match, to any and all subscribed users.

### SUMMARY OF THE INVENTION

The present invention is directed to a system, method and computer program for receiving and publishing details of sporting events in real-time, for example, during the course of the event. In certain embodiments, a game official, referee, score keeper or administrative user associated with a team may input event details, such as scoring events, player misconduct, substitutions, etc., during the course of the event. Other users who have subscribed to a participating team or the event will receive the event details in real-time, for example, via a scrolling scoreboard, push or other notifications, or a dynamic scorecard accessed via the user's profile or account.

For example, once the event details are provided by the authorized user (e.g., the official, referee, score keeper or administrative user), the data is automatically saved at a remote data processing and/or management device and then pushed to subscribed users globally. As a result, people anywhere in the World who are interested in receiving the official scorecard of any game, or receiving event details pertaining to any game in the World, can subscribe and receive the data, in real-time, or on demand. The event details may be communicated via a push or other notification (including text message, email, etc.), displayed via a scrolling scoreboard on the user's device or user account/profile, and/or presented in a dynamically updated scorecard.

These and other objects, features and advantages of the present invention will become more apparent when the drawings as well as the detailed description are taken into consideration.

### BRIEF DESCRIPTION OF THE DRAWINGS

FIG. 1 is a high level flow chart illustrating the method for receiving and publishing details of sporting events in real-time, as disclosed in accordance with at least one embodiment of the present invention.

FIG. 2 is an exemplary screenshot or GUI illustrating a user registration in accordance with the present invention.

FIG. 3 is an exemplary screenshot or GUI illustrating the environment for searching for and adding one or more teams to a user's profile or scoreboard.

FIG. 4 is an exemplary screenshot or GUI illustrating the environment for searching for matches or events to which the user may choose to subscribe in order to receive event details corresponding thereto in accordance with at least one embedment disclosed herein.

FIG. 5 is an exemplary screenshot or GUI illustrating a list of events to which the user may subscribe in order to receive event details corresponding thereto in accordance with at least one embedment disclosed herein.

FIG. 6 is an exemplary screenshot or GUI illustrating match events or event details corresponding to a selected event.

FIG. 7 is an exemplary screenshot or GUI illustrating chat logs or user comments pertaining to a selected event.

FIG. 8 is an exemplary screenshot or GUI illustrating a user profile as disclosed in accordance with at least one embedment of the present invention and in order to facilitate social interaction between users.

FIG. 9 is an exemplary prior art scorecard physical scorecard oftentimes used by officials during the course of an event or match.

FIG. 10 is an exemplary screenshot or GUI illustrating a list of matches or events in which an official may check into an officiate in accordance with the present invention.

FIG. 11 is an exemplary screenshot or GUI illustrating the creation of a new match or event by an official or other authorized user.

FIG. 12 is an exemplary screenshot illustrating a data provider home screen allowing for the input of various event data, such as scores, misconduct and substitutions in accordance with the present invention.

FIG. 13 is an exemplary screenshot or GUI illustrating the environment wherein a data provider may input data corresponding to a new score in accordance with at least one embodiment of the present invention.

FIG. 14 is an exemplary screenshot or GUI illustrating the environment wherein a data provider may input data corresponding to misconduct in accordance with at least one embodiment of the present invention.

FIG. 15 is an exemplary screenshot or GUI illustrating the environment wherein a data provider may input data corresponding to a substitution in accordance with at least one embodiment of the present invention.

FIG. 16 is a block diagram illustrating the system for receiving and publishing details of sporting events in real-time, as disclosed in accordance with at least one embodiment of the present invention.

FIG. 17 is a block diagram illustrating the exemplary components of the data processing and/or management device in accordance with at least one embodiment of the present invention.

FIG. 18 is a block diagram illustrating the exemplary components of the input device(s) and user device(s) in accordance with at least one embodiment of the present invention.

Like reference numerals refer to like parts throughout the several views of the drawings provided herein.

### DETAILED DESCRIPTION OF THE INVENTION

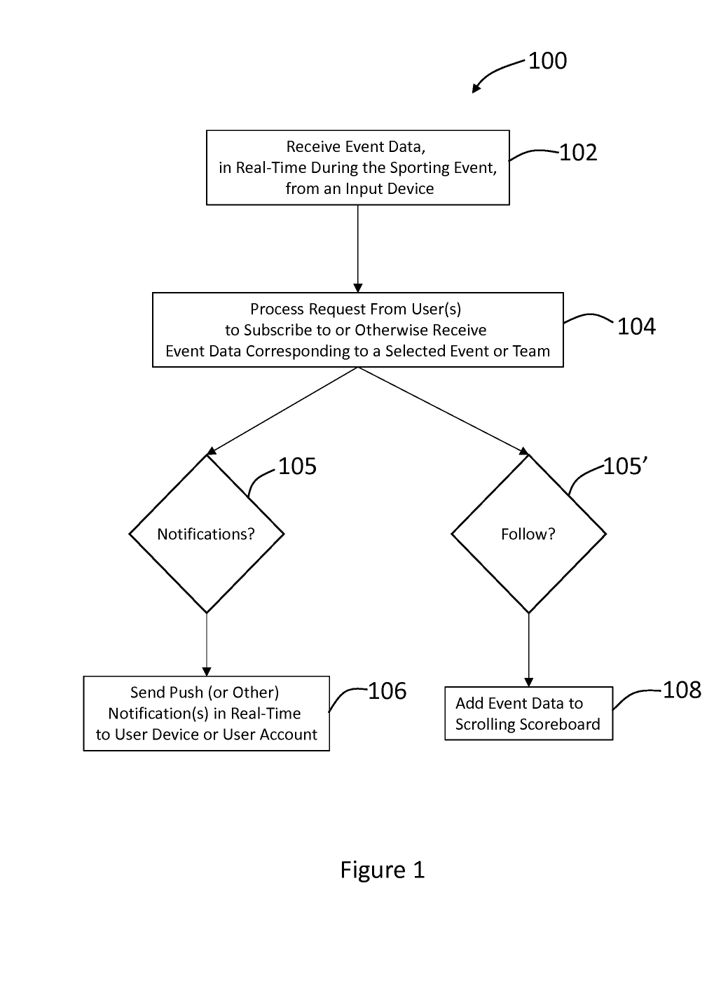

As shown in the accompanying drawings, and with particular reference to FIG. 1, at least one embodiment of the present invention, as disclosed herein, is directed to a method for publishing details of at least one sporting event, as generally shown by reference character 100. Specifically, the various embodiments of the present invention are provided to allow the real-time recording and publishing of event details corresponding to one or more sporting events, particularly, for under reported niche sports, including but certainly not limited to, for example, rugby, lacrosse, soccer, hockey, field hockey, crew, water polo, baseball, softball, extreme sports, etc. Accordingly, the event details and/or data related to these sports, and others, whether at an amateur level, little league, children's sports, under 18, high school, club level, grass roots, college, or professional level, may be reported to a remote processing device, stored or recorded thereby, and/or published to registered users in real-time, for example, during the course of the game, sport or event.

Moreover, still referring to the high level flow chart illustrated in FIG. 1, at least one embodiment of the method 100 comprises receiving event data or details in real-time during the course of the sporting event 102, processing one or more requests from user accounts to receive event data corresponding to one or more selected events and/or one or more selected teams 104, and communicating the event details to the user, for example, via push notification to the user's device 106 and/or adding the event details to a scrolling scoreboard or scrolling display associated with the user's account 108. Particularly, as will be described in further detail herein, the user may subscribe to a particular team or event, or otherwise opt to receive the event details and/or data corresponding to a selected event or team via a notification 105 and/or opt to follow a selected event or team 105′.

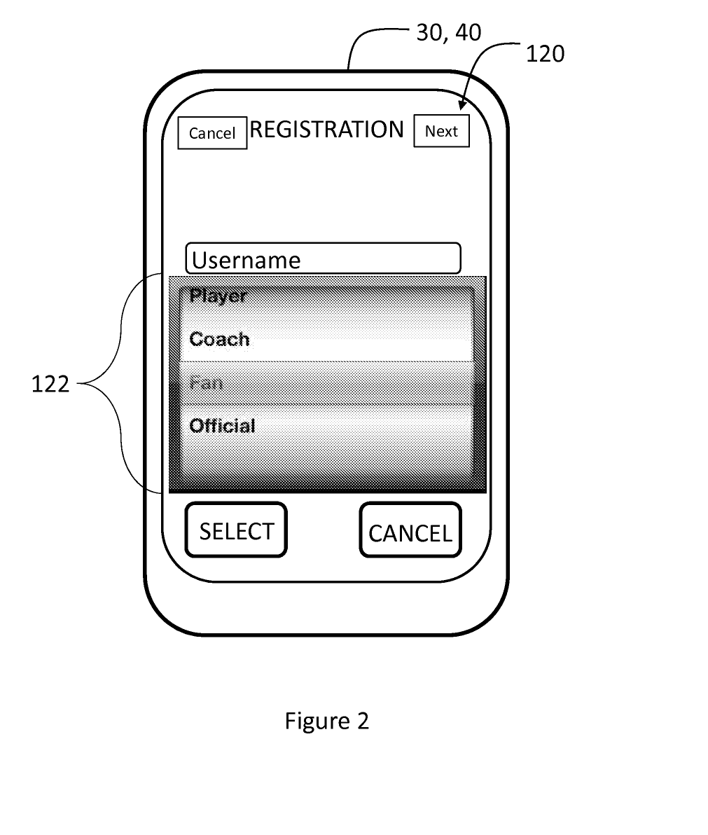

Further, as shown in FIGS. 2 through 8, and FIGS. 10 through 15, there is shown an exemplary graphical user interface (“GUI”), generally referenced as 120, that can be accessed, executed or provided in an appropriately and cooperatively configured computer or processing system and/or user device for implementing certain embodiments of the present invention as disclosed herein. For instance, a user may, in certain embodiments, first register with the system or processing device of the present invention. As generally shown at selection box 122 of FIG. 2, the user may register as a “player,” “coach,” “fan,” or “official.” Other designations or characterizations of the user(s) may be provided. Depending on the particular registration designation, the corresponding user will be provided different access or abilities within the system. It should also be noted that a user may register under more than one designation, particularly if the user is an “official” for certain events, but also a “fan,” “coach,” or “player.” As will be described below, if the user is registered as an official, then that user may then access the official module(s) or component(s) which allow that user to input certain event details or data in real-time, including, but not limited to start and end times, quarter, period or half times, scores, player misconduct or fouls, substitutions, etc.

Once registered, the user will then create a user profile associated with the account, for example, by entering certain identifying or personal information such as, but certainly not limited to name, address, date of birth, email address, phone number, username, password, etc. If the user is a player, for example, the user may also input his or her team(s), position(s), jersey number(s), height, weight, age, etc. If the user is a coach, the user may provide information relating to the team(s) he or she coaches, how long he or she has coached, whether he or she previously or currently plays the sport or another sport, etc.

Upon registration, or within the user's account subsequent to registration, the user may also select one or more of his or her favorite teams or teams in which he or she would like to follow, subscribe to, or otherwise receive notifications as to event details. Upcoming or scheduled events or games may also be selected in which the user would like to receive communications relating to the event details. As will be provided herein, push notifications of the event details or data may be provided to the user's device (e.g., cellular phone, mobile device, tablets, computer, etc.) or the event details or data may be added to a scrolling display or scrolling scoreboard provided or otherwise accessible on the user's profile, account, or device.

Moreover, a user may be designated as an administrator, for example, of a particular team, allowing that designated or authorized user to have administrative access to the team's profile or account and/or allowing that designated or authorized user to provide certain event details in real-time associated with the particular team. For example, in at least one embodiment, a user may simply select or designate himself or herself as a team administrator, although other embodiments may require an application or requesting permission from the system of the present invention before administrative access is granted or provided. For instance, the system or method of at least one embodiment of the present invention may only allow one administrator per team, and thus, if another user is already designated as an administrator of a particular team, any subsequent applications or requests to become an administrator will be denied or rejected. Once a user is designated as an administrator, the user may assign administrative rights to other users, if desired. It should be noted that certain embodiments may allow multiple administrative users assigned to a single team.

Furthermore, once a user is designated as an administrator of a particular team, the user may then report event details corresponding to events involving that team. For example, the administrative user may report scores or goals, time(s) (start and end times, quarter, period or half times, penalty times, etc.), player misconduct (e.g., fouls, penalties, etc.), player substitutions, etc. Event details or data may also include photographs, video, audio, animations, etc. Moreover, in certain embodiments, the administrative user may use his or her user device or input device for providing the event details or data, which may include a mobile phone, mobile device, tablet, laptop computer, desktop computer, PDA, etc. It should be noted that in certain embodiments a program or application may be downloaded, installed, executed or accessed (either locally or remotely) by the user or input device in order to facilitate implementation of the present invention in the intended manner, and allowing the administrative user to provide the event details. For instance, the program or application may be structured to access a remote server or processing device which is structured to receive the event details, manage user accounts, and/or otherwise implement various features of the present invention as disclosed herein. It is also contemplated that the administrative user may access a website or cloud-based application for accomplishing the same.

It should also be noted that the administrative user may edit or manage the corresponding team's schedule, logo, provide directions to the team's facilities or practice, send notifications to team members, players, coaches, etc.

As should be apparent, the team administrator of at least one embodiment of the present invention is particularly useful for little league teams, high school teams, children teams, etc., wherein the scores and other event details can be provided to the system and method of the present invention, in real-time (i.e., during the course of the event) and notifications (e.g., via push notifications, scrolling display, etc.) can be provided to other users (e.g., parents, fans, family members, etc.) who may not otherwise be able to attend the event. As many little league, high school, club, and children's teams are not televised, not reported, and/or are otherwise under reported, without the use of the present invention, details pertaining to the event(s) are difficult to obtain, especially in real-time, from user who may not be able to attend the event.

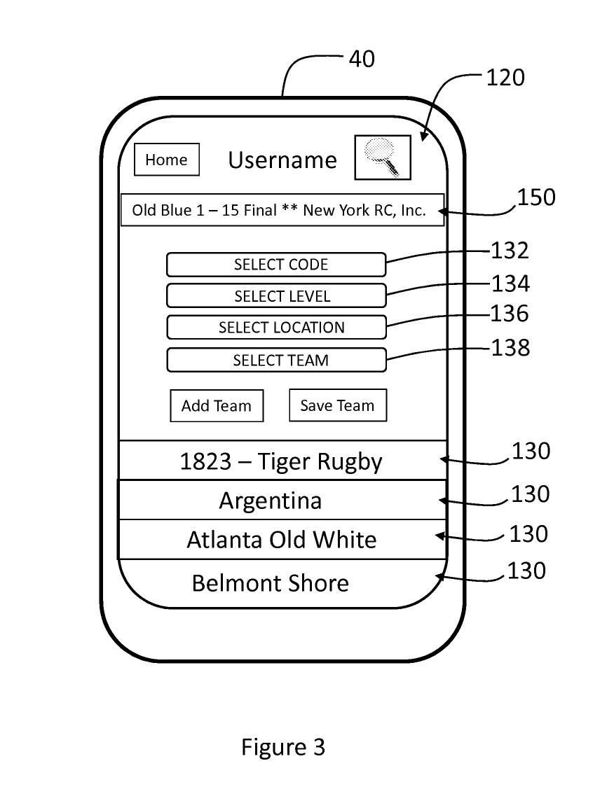

As provided above, the method 100 of at least one embodiment comprises processing a request to receive event data corresponding to a selected event or a selected team 104. Specifically, referring to the exemplary screenshot or GUI of FIG. 3, the user(s) may search for, browse or otherwise identify one or more teams 130 in which the user would like to receive event details or data. For example, under a “My Scoreboard” tab (or other designated screen or selection), the user may browse for a particular team by entering or specifying a team code 132 (e.g., a unique code or number assigned to each team), team level 134 (e.g., little league, peewee league, high school, club, college, professional), team location 136 (e.g., country, state, county, city, etc.) and/or by entering the team name or other search term 138.

The user may elect to follow the team or otherwise add the selected team 130 to the user's scoreboard 150, where certain event details and/or data may be displayed, as described herein. On the other hand, the user may elect to receive notifications as to event details corresponding to the selected team, instead of or in addition to following the selected team. In such a case, the system or method will generate or otherwise communicate push notifications to the user's device, wherein the push notifications are directed to or otherwise include the event details or data, such as the score(s), times, player misconduct, substitutions, etc. Particularly, the push notifications may be directed to the application or computer program and therefore directed to the user's device where the application resides, as an example. Other communications, such as text message, email, etc., may also be implemented within the full spirit and scope of the present invention.

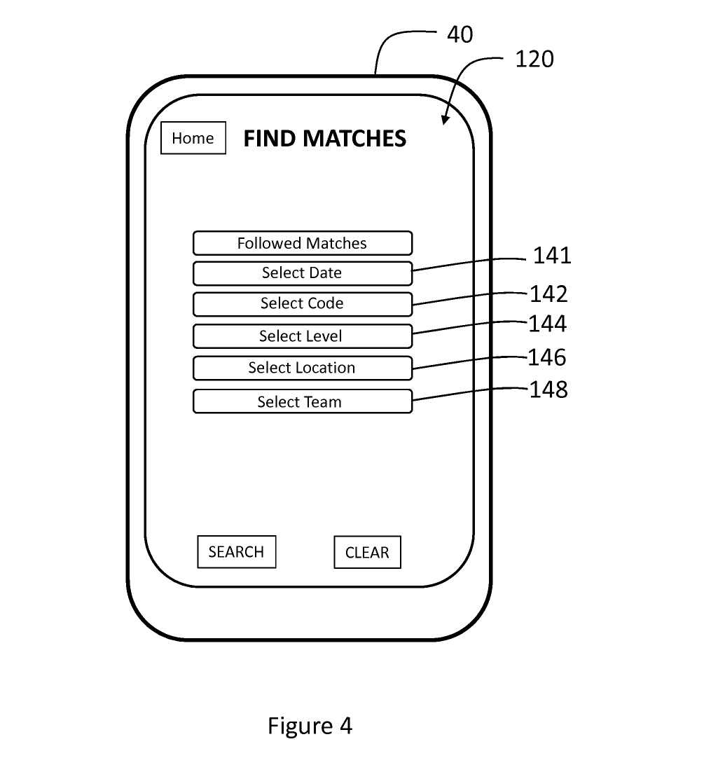

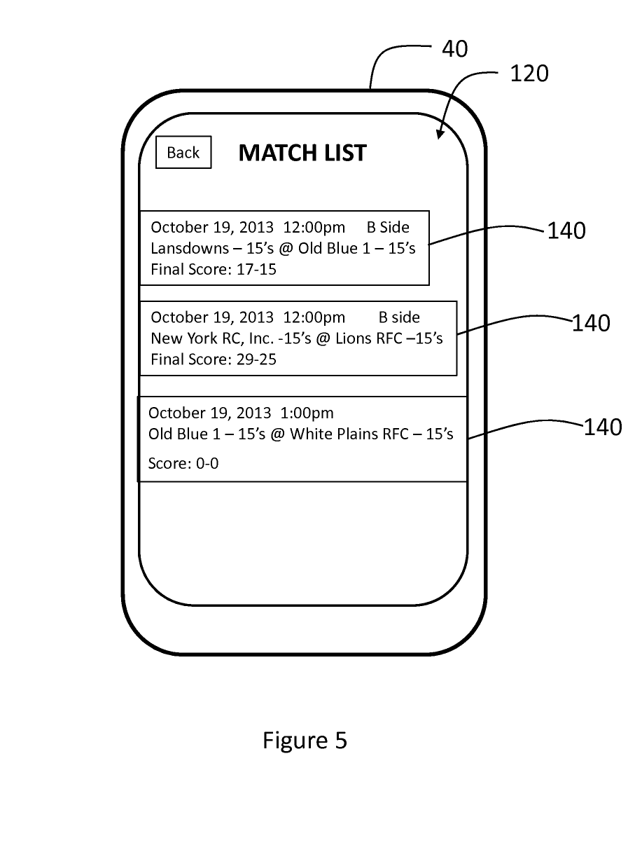

Referring now to the exemplary screenshots or GUIs of FIGS. 4 and 5, the user may instead or also search for, browse or otherwise identify one or more games, events or matches 140 in which the user would like to receive event details or data. For instance, may browse for a particular game, match or event 140 by entering or specifying a date 141 (e.g., day, month, year), event code 142 (e.g., a unique code or number assigned to each event), event level 144 (e.g., little league, peewee league, high school, club, college, professional), event location 136 (e.g., country, state, county, city, etc.) and/or by entering a team name or other search term 148.

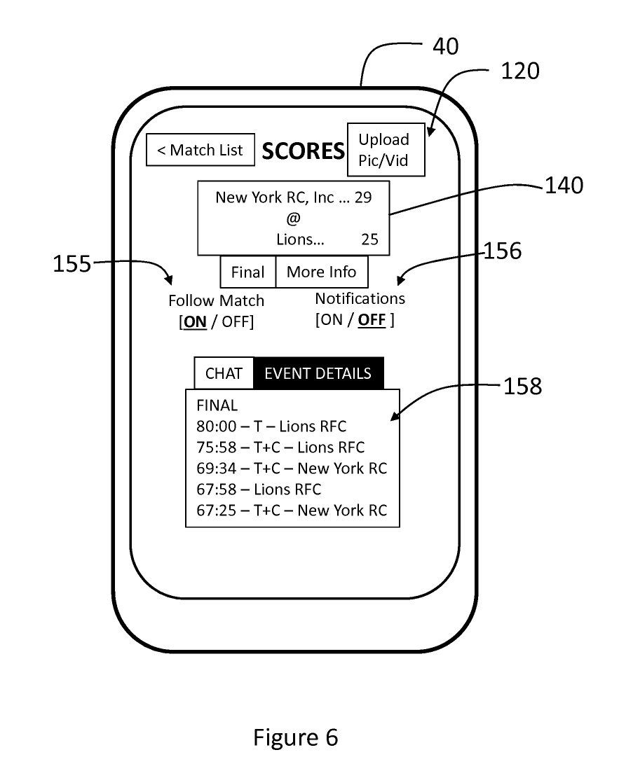

For instance, as shown in the exemplary screenshot or GUI of FIG. 6, the user may select a particular match or event 140 and elect to “follow” the event, as provided at 155 and/or receive notifications corresponding to the event, as provided at 156. If the user elects to follow the event, then certain event details or data will be provided or displayed on a scoreboard 150. On the other hand, if the user elects to receive notifications as to event details, instead of or in addition to following the event, then the system or method will generate or otherwise communicate push notifications (or other notifications) to the user's device, wherein the push notifications are directed to or otherwise include the event details or data, such as the score(s), times, player misconduct, substitutions, etc. Particularly, the push notifications may be directed to the application or computer program and therefore directed to the user's device where the application resides, as an example. Other communications, such as text message, email, etc., may also be implemented within the full spirit and scope of the present invention. Still referring to FIG. 6, the event details or data may be provided via a list 158 or other manner within the application or GUI, for instance by selecting a “Match Events,” or other button.

Referring again to the screenshot or GUI of FIG. 3, the scoreboard 150 of at least one embodiment of the present invention may include a display providing details or data (e.g., scores) of an event (e.g., game or match) involving the selected team(s) 130 and/or selected events 140 (FIG. 6). In one embodiment, the display or scoreboard 140 may be actively accessed, for example, by selecting a “My Scoreboard” (or equivalent) button or otherwise navigating to a designated portion of the application. Other embodiments may display the scoreboard 140 throughout the application, and in a plurality of view or screens such that the scoreboard is always or oftentimes present at a designated or selected position, e.g., at or near the top of the screen, as shown in FIG. 3. Of course, certain embodiments will allow the user to select or specify the display options corresponding to the scoreboard 140 and in particular when and where the scoreboard 140 is displayed. It should also be noted that in at least one embodiment, the scoreboard 140 may be displayed on the user's screen or device independent of other screens or GUI's shown herein. For example, the scoreboard 140 of one embodiment may be displayed on the user's screen or the device screen (e.g., mobile device, mobile phone, tablet, laptop computer, desktop computer, etc.), as the user navigates other non-affiliated applications, websites, etc.

Furthermore, in certain embodiments, the display or scoreboard 140 may scroll or otherwise move across the screen in a predetermined direction (e.g., from left to right, or from right to left), allowing for data or details corresponding to multiple events or teams to be consecutively displayed or scrolled across the user's screen. As provided herein, the user may select or otherwise customize the event data displayed in the scoreboard 140, for example, by selecting a particular team and/or event. The order of the event data presented on or displayed by the scoreboard 140 may also be modified or specified by the user.

Furthermore, the user may interact with the scrolling scoreboard and change or modify the predetermined or default scrolling speed and/or direction. For example, in at least one embodiment, the scrolling speed of the scoreboard 140 may be altered or modified by user interaction or user input, such as in the form of a gesture (e.g., swipe, tap, etc.), or button selection. For exemplary purposes only, the user may swipe from right to left across the screen and in contact with the scoreboard 140 in order to modify the scrolling speed from right to left. The fast the swipe, the faster the system or method of the present invention alters or adjusts the scrolling speed. Further, the scrolling direction may similarly be adjusted, for instance, via a directional swipe across the scoreboard 140. As an example, swiping a finger from right to left may cause the scoreboard to scroll in a right-to-left direction, whereas swiping a finger from left to right may cause the scoreboard to scroll in a left-to-right direction. Moreover, the left and right directions are presented as illustrative only, and other embodiments may display or scroll a scoreboard in other directions, e.g., up and down.

It should be apparent from the description herein, that in certain embodiments, at least some of the event data or details that are provided within or otherwise displayed by the scoreboard 140 are derived from or received in real-time (e.g., during the course of the event and as the event takes place) from the administrative user and/or an official or referee officiating the event. Accordingly, the system and method of the present invention may be structured to receive the event details from the authorized user (e.g., administrative user or official) in real-time, and immediately (i.e., as the system or method receives the data) publish or communicate the data to the user's account or scoreboard and/or communicate push (or other) notification to the users, as specified.

Moreover, certain embodiments of the method 100 of the present invention further include providing social interaction capabilities between a plurality of the users. For instance, as provided herein, the social interaction capabilities may include, but is not limited to live or real-time chat between users, maintaining a social profile for each user, and a selected exchange of media (e.g., photographs, pictures, animation, audio, video, etc.) between users.

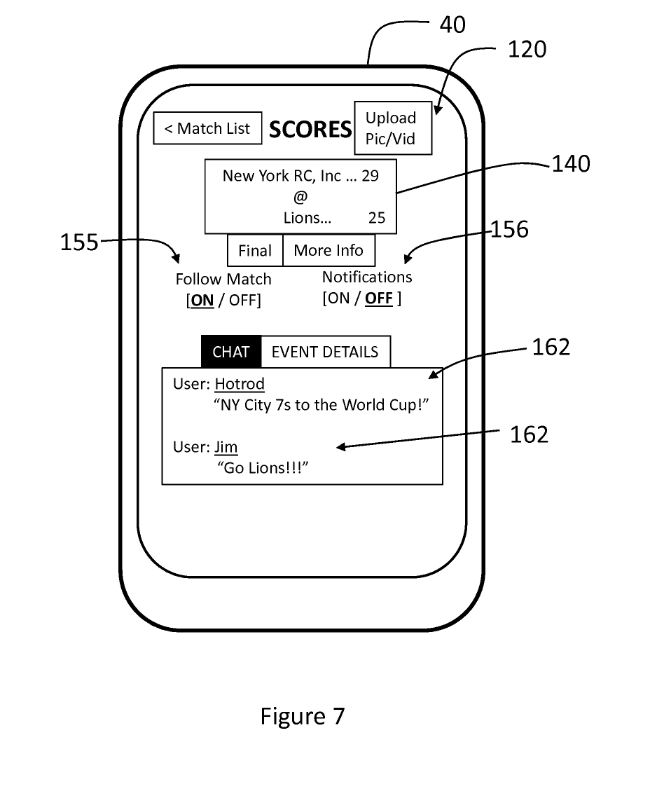

For example, referring to the screenshot or GUI of FIG. 7, users may add comments 162 to pages or displays corresponding to a selected event 140. In particular, as above, user may browse for particular events or teams in order to follow the event or team and/or receive notifications pertaining thereto. In one embodiment, users may also submit live, real-time comments or media 162, for example by selected a “chat” button or icon. Upon submission of the comment(s) or media 162, other users on the same or similar screen within the application may view the submitted comments or media and, if desired, submit comment(s) or media as well.

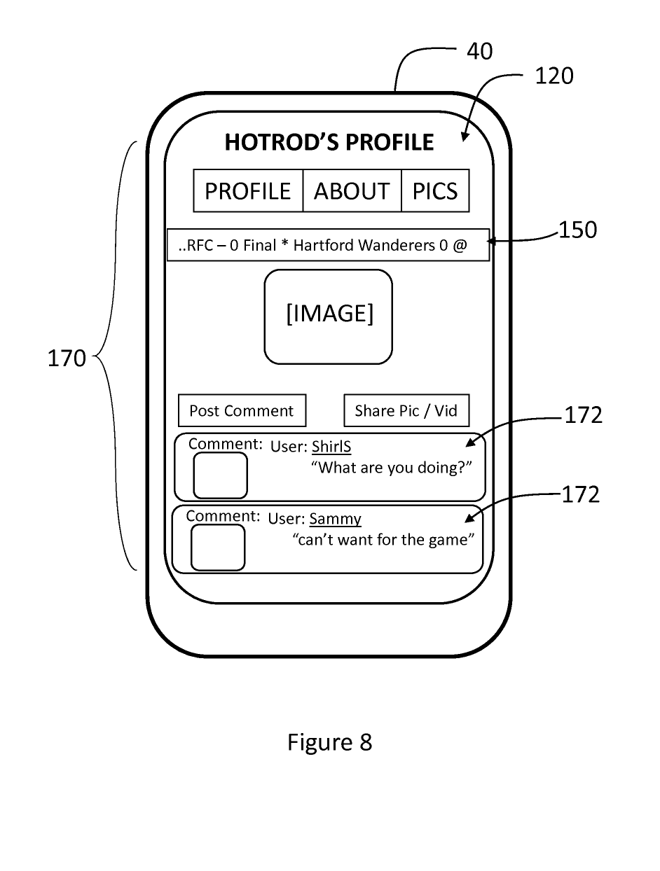

Referring now to FIG. 8, users of at least one embodiment may also create and maintain a profile page 170. It should be noted that the comments, media and other profile data 172 are stored and/or processed or managed by a processing device or server. The processing device, as provided below, is structured to manage the various profiles provided herein. Particularly, still referring to FIG. 8, a user's profile page 172 may include images, video, audio, comments, and other profile data 172. The user may post or share media to his or her own profile, viewable by other users (or authorized users, such as friends). Certain embodiments further allow users to post or share media or comments on other user's profiles, as desired.

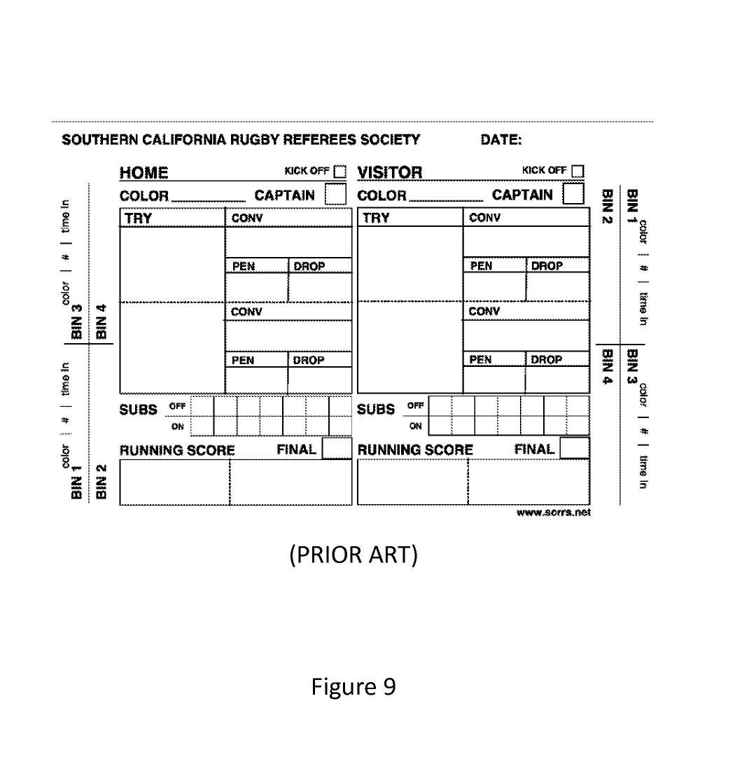

As provided herein, certain embodiments of the present invention are structured to eliminate the need for authorized individuals (e.g., referees, officials, score keepers, team administrators, etc.) to carry around a stopwatch or separate time keeper, and fill in scorecards, for instance, via pencil and paper, or laminated, dry-erase cards, during the course of the game. An exemplary scorecard, often in the form of paper or a laminated plastic card, is shown in the exemplary illustration of FIG. 9.

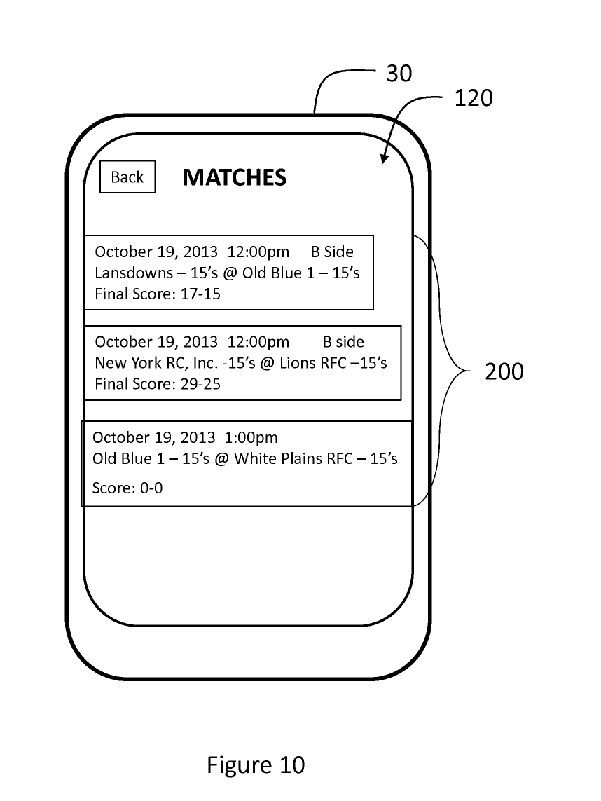

Specifically referring to FIG. 10 through 15, exemplary screenshots or GUIs of at least one embodiment of the present invention are provided which allow an authorized user 12, such as an official, score keeper or administrative user, to input event data corresponding to a sporting event. Particularly, the event data is provided by the user 12 via an input device 30 operated by the authorized user 12. The input device 30 may be a designated device structured to provide the user with the functionality as described herein sufficient to facilitate the input of data or media. However, the input device may also include a cellular or mobile telephone, mobile device, tablet, PDA, etc.

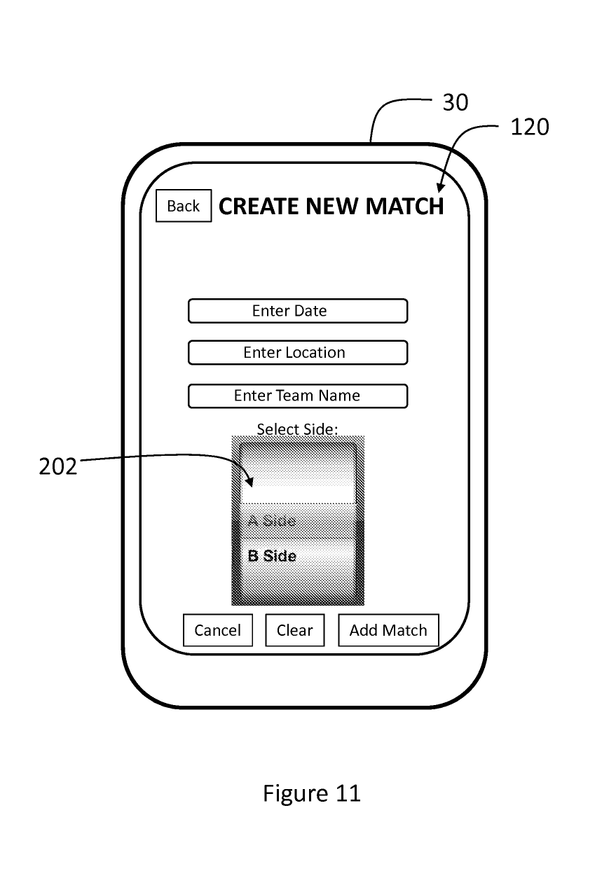

More in particular, before the match or game begins, the authorized user 12 or data provider may open or access a corresponding application 50 on the particular input device 30. The authorized user or official 12 may log into the application 50, for example, by providing an identification number/code, username, passwords, etc. The official 12 or other authorized user may then search for the particular match or event he or she will be officiating or reporting event data. Specifically, the event may be searched by entering a unique event ID, date, code, level, team names, location, or other search criteria. Upon receipt of the search criteria, the system and/or method of the present invention may display a list 200 of events meeting the criteria, as generally shown in FIG. 10. The official or data provider 12 may then select the event listed. If the event is not listed, the data provider 12 may create a new match or event, as generally shown in FIG. 11. In such a case, the data provider 12 will enter the names of the teams, as generally shown at 202, and other information corresponding to the event, such as the date, time and location.

Once the event is selected or created, and the user has checked into the event, the system or method of the present invention will link the data provider 12, such as the official, referee, score keeper, or administrative user, with the event in a manner that will allow the user 12 to provide event details and data in real-time, i.e., as the event progresses. Particularly, during the course of the event, and while the event is linked to the authorized user's input device 30, each time the user or data provide 12 adds or modifies event data, the system and/or method of the present invention will correspondingly receive the event data therefrom and publish the data or details to other users who have elected to follow the match or one of the teams participating in the match and/or send notifications to those uses who have elected to receive notifications corresponding to the event or one of the teams participating the even, as described herein.

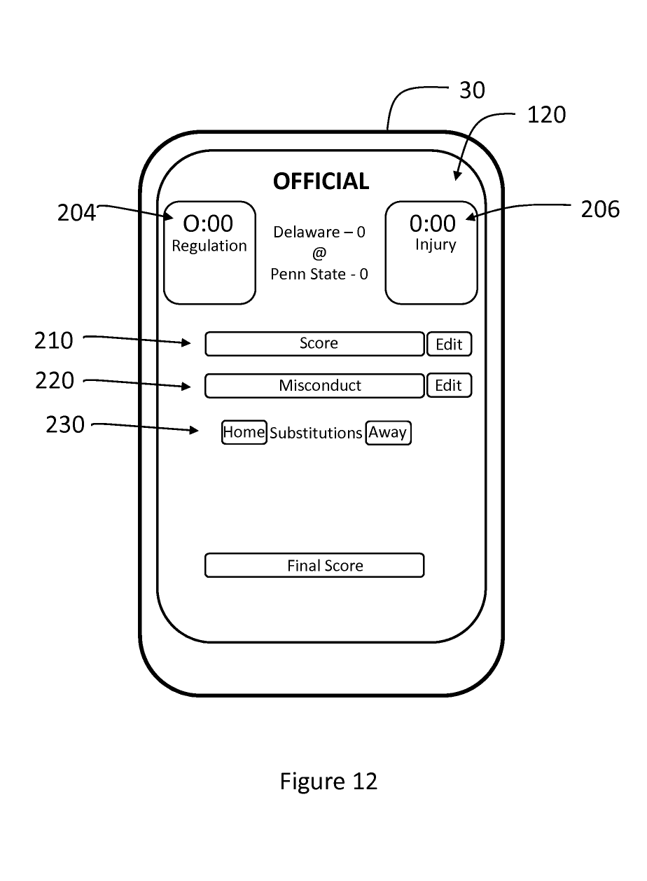

Moreover, referring to the exemplary screenshot or GUI of FIG. 12, the data provider or authorized user 12 may control a primary clock 204 and/or a secondary clock 206, enter or adjust the score 210, enter or adjust player misconduct events 220, and/or enter or adjust player substitutions 230.

Referring to the primary and secondary clocks 204, 206, the data provider 12 may start and stop the clocks as necessary to control, manage and maintain the time of the event, e.g., quarter, period, or half times. A designated button for each of the clocks 204, 206 may be activated to start and stop the clocks. For example, the primary clock 204 may be started at the beginning of the game, quarter, period, or half. The user may press and hold the clock 204 to skip a quarter, period or half, if necessary. The secondary clock 206 may be used to keep or record extra time, sometimes referred to as injury time, particularly in soccer or rugby matches. For example, while the primary clock is running, the user may start and stop the secondary clock 206 as needed to record extra time. When the primary clock 204 expires or reaches the designated time, the secondary clock 206 may then begin to count down or run.

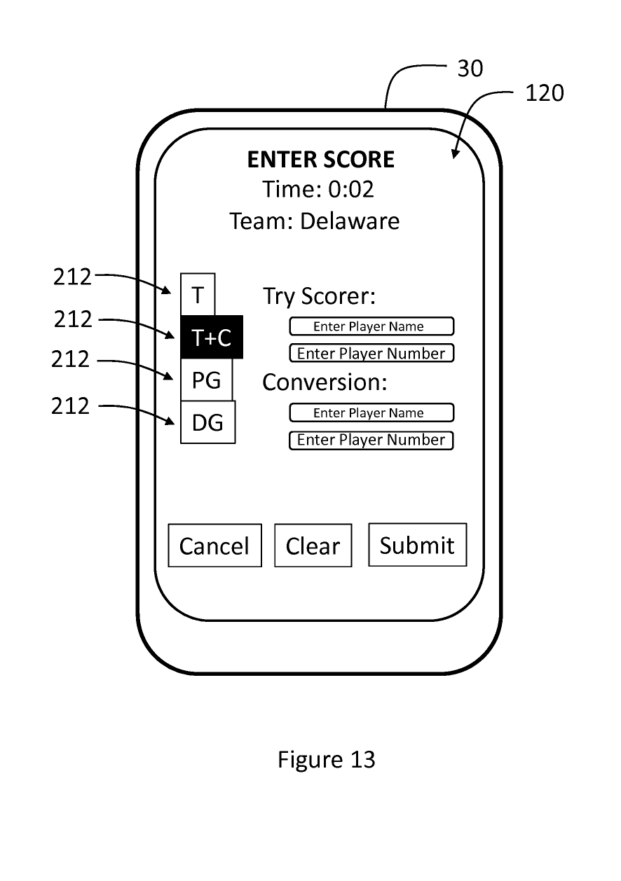

Activating the “score” button 210 of FIG. 12 may open the score module or display in FIG. 13, allowing the data provider 12 to enter a score of the match or event. As an example, the score may be recorded via one or more codes or designators 212, along with an identification of a player, for example, by jersey number, name, position, team, etc. It should be noted that the player information (e.g., number, name, position, team, etc.) may be prepopulated by the system or method of the present invention (via data stored on the remote processing device 20), such that the data provider may select the player information therefrom, via a spin wheel, drop down box, etc.

For exemplary purposes only, and as may be common in the sport of rugby, the codes may include “T” for try only, “T+C” for converted try, “PG” for penalty goal, and “DG” for drop goal. Other codes or designations may be used or implemented within the full spirit and scope of the present invention. Further, once the score screen of FIG. 12 is activated, for example, by activating the “score” button from the previous screen in FIG. 11, a timestamp is recorded. Thus, when the data provider finalizes or otherwise submits the score data, for example, by entering the code, name, position, number, team, etc., the data is communicated in real-time to the data management or processing device 20 of the present invention. The data management or processing device 20 is structured to then receive the data, record the data and publish or communicate the data to the designated users, as described herein, in real-time.

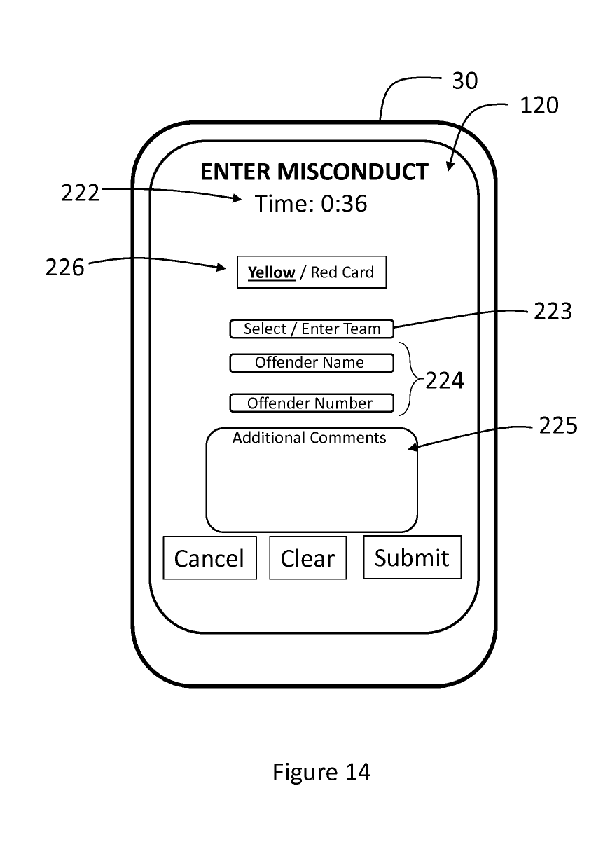

Activating the “misconduct” button 220 of FIG. 12 may open the misconduct module or display in FIG. 14, allowing the data provider 12 to enter data corresponding to player misconduct during the course of the event. For instance, misconduct as used herein may include a penalty, infraction, foul, issuance of a yellow/red card, etc.

Moreover, once the misconduct button is activated, the system and method of at least one embodiment is structured to record a timestamp 222 or otherwise record the time (e.g., on the game clock). The data provider 12 may then identify the team of the offending player 223, the offending player information 224 (e.g., name, number, position), and/or a brief description of the misconduct 225. For instance, the description could include a description of the misconduct committed, what action the official took relating to the misconduct, and other entries. Certain embodiments, particularly when the event is soccer or rugby, will also include a red/yellow card selection 226 or other similar designation, if applicable. It should be noted that the misconduct information provided herein 223-226 may be modified prior to submitting the final score, if desired or if necessary. Further, the misconduct information 223-226 may be prepopulated via drop down boxes, spin wheels, etc. allowing the data provider to select the appropriate entry, rather than tying it in from scratch. For example, by virtue of being checked into a particular game, the processing device 20 of at least one embodiment may populate the player information based upon stored data. A description of the action taken may be selected from a predetermined set of actions, etc.

Once recorded or submitted, the event data corresponding to the misconduct may be communicated to the processing device 20 and thereafter communicated or published to the appropriate subscribed users, as described herein.

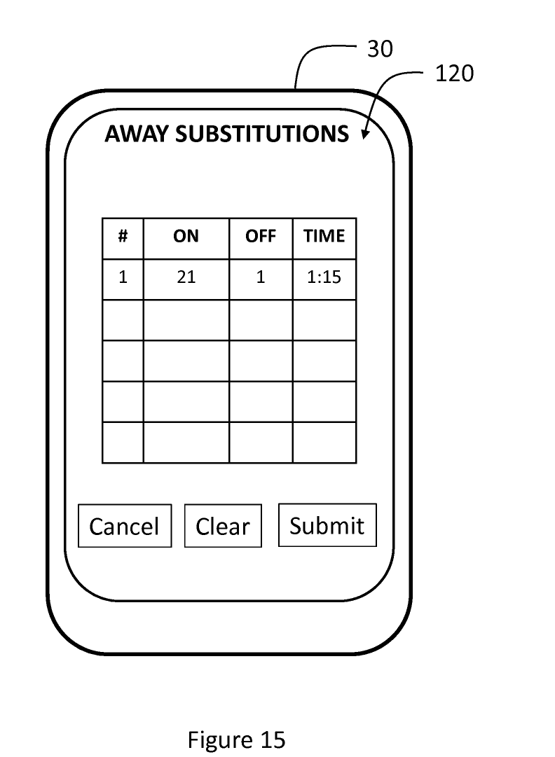

Activating the “substitution” button 230 of FIG. 12 may open the substitution module or display in FIG. 15, allowing the data provider 12 to enter data corresponding to player substitutions during the course of the event. For instance, at least one embodiment of the present invention allows the data provider 12 (e.g., referee, official, administrative user, etc.) to keep track of the substitutions for each side or team of the event. This is particularly important in some sports or events which may limit the number of substitutions allowed per side during the course of the event. Accordingly, upon activating the substitution module shown in FIG. 14, the system and/or method may record a timestamp, for example, corresponding to the current time on the game clock. A team may be selected, and player information (e.g., number, name, position, etc.) may be provided for the players entering and exiting the game for the particular substitution. Each team (e.g., Home and Away) may have a different substitution input screen. For example, FIG. 15 shows the Away substitution input screen.

Once recorded or submitted, the event data corresponding to the substitution(s) may be communicated to the processing device 20 and thereafter communicated or published to the appropriate subscribed users, as described herein.

For example, the users may subscribe to or elect to receive event data corresponding to a particular selected team or event, as mentioned above. In such a case, the processing device 20 is structured to receive the data provided by the input device 30 and in real-time publish or communicate that data to the corresponding user account. For example, the event data or details may be provided via a scrolling scoreboard 140 and/or via push or other notifications. It should also be noted that a user may view a scorecard within his or her account or profile, wherein the scorecard is structured to provide or publish data in real-time corresponding to the score data, misconduct data, substitution data, etc.

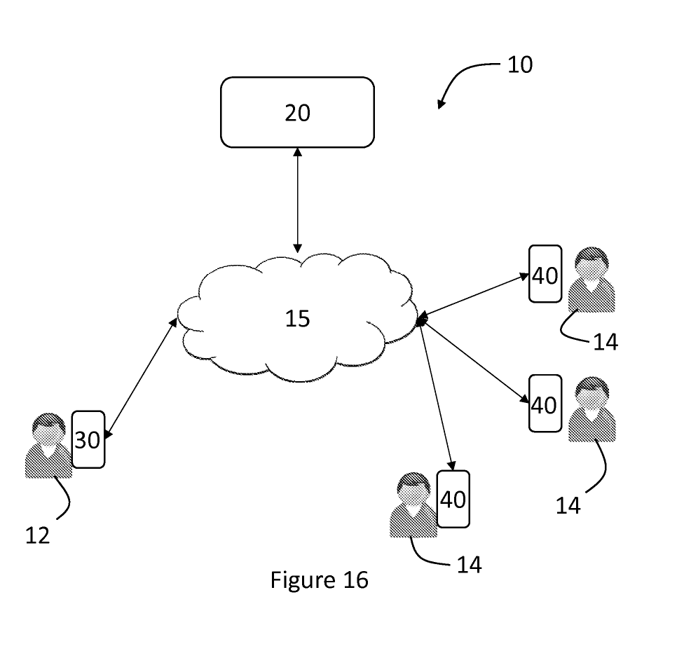

Furthermore, referring to FIG. 16, at least one embodiment of the present invention includes a system 10 for publishing details of at least one sporting event. Particularly, the system 10 of is structured to implement the method, as described herein, via one or more processing devices 20, 30, 40. For instance, as shown in FIG. 16, the system 10 of at least one embodiment comprises a data processing and/or management device 20 disposed in a communicative relation with at least one input device 30 and at least one, but more practically, a plurality of user devices 40.

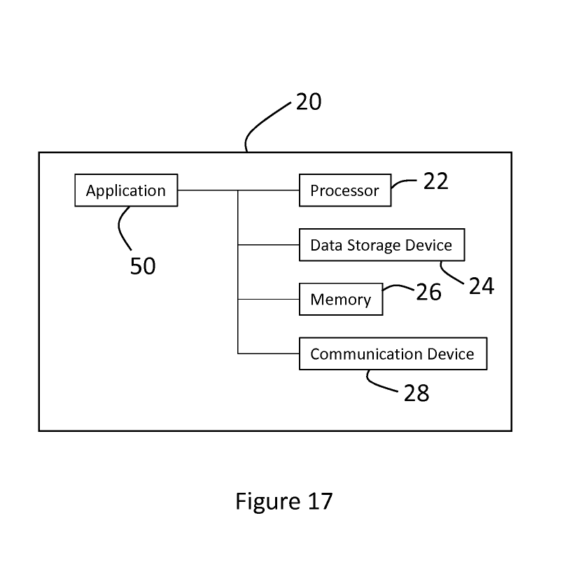

It should be noted that the data processing and/or management device 20 is structured to manage the plurality of user profiles and user accounts, as described herein. Further, the data processing and/or management device 20 is structured to receive event data from the input device(s) 20 and publish or communicate the event data to one or more user accounts or user devices 40. Accordingly, as shown in the block diagram of FIG. 17, the data processing and/or management device 20 comprises a processor 22, data storage device 24, memory 26 and a communication device or communication hardware 28. Specifically, as used herein, the processor 22 may include any device cooperatively structured to execute or implement computer instructions, software, etc., including, for example, the application 50 as described in accordance with at least one embodiment of the present invention and configured to implement the method 100 herein. The data storage device 24, as used herein, may include a hard disk drive, CD/DVD, USB drive, solid state drive, virtual drive, could-based storage drive, or other types of volatile or non-volatile memory. Further, the memory device 26 as used herein, may include but is not limited to random access memory (RAM) or other like devices configured to implement the present invention in the intended manner, for example, by at least temporary storing and assisting with the execution of one or more applications 50 capable of implementing the system 10 and method 100 described herein. Moreover, the communication device 28 may include a network communication hardware/software component structured to facilitate communication between the various processing devices 30 (input device) and 40 (user device) of the present invention.

Accordingly, examples of the data processing and/or management device 20 of the present invention may include a web or cloud-based computer or server, desktop computer, laptop computer, tablet, mobile or handheld computer, etc.

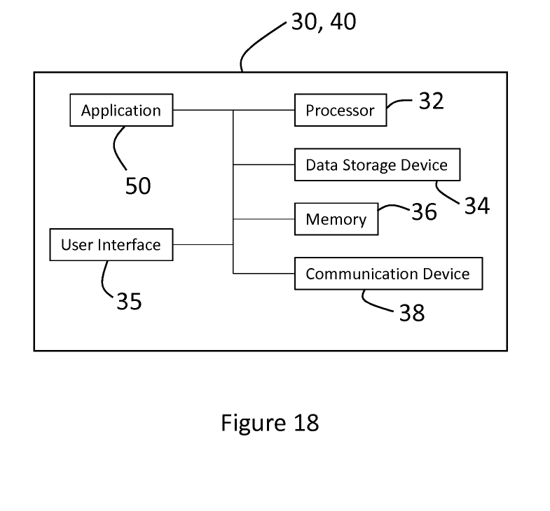

Further, as described herein, the input device(s) 30 are accessible or otherwise operated by an authorized user 12 such as an official, referee, score keeper, and/or the administrative user for a particular team. In addition, the user device(s) 40 are accessible or otherwise operated by a user 14 of the system 10 or method 100. Particularly, as shown in FIG. 18, the input device 30 and user device 40 each include a processor 32, data storage device 34, memory 36 and communication hardware 38. Specifically, as used herein, the processor 32 may include any device cooperatively structured to execute or implement computer instructions, software, etc., including, for example, the application 50 as described in accordance with at least one embodiment of the present invention and configured to implement the method 100 herein. The data storage device 34, as used herein, may include a hard disk drive, CD/DVD, USB drive, solid state drive, virtual drive, could-based storage drive, or other types of volatile or non-volatile memory. Further, the memory device 36 as used herein, may include but is not limited to random access memory (RAM) or other like devices configured to implement the present invention in the intended manner, for example, by at least temporary storing and assisting with the execution of one or more applications 50 capable of implementing the system 10 and method 100 described herein. Moreover, the communication device 38 may include a network communication hardware/software component structured to facilitate communication with the data processing and/or management device 20 in order to implement the present invention in the intended manner. Certain embodiments of the input and user devices 30, 40 further include a user interface 35 which may be structured to facilitate local and/or remote communication such as by entering data, inputs, or instructions, as well as providing output(s) to the user via a display screen. Accordingly, the user interface(s) 35 may include, for example, a physical or virtual keyboard, mouse, touchscreen, video input device, audio input device, monitor or display screen, printer, speaker, etc.

Accordingly, while the input device 30 is typically a mobile device, such as mobile phone, tablet, or a designated mobile device structured to implement the features herein, particularly when used or operated by an official during the course of the event, other examples of the input device 30 include a desktop computer, laptop computer, etc. Further, examples of the user devices 40 may include any mobile device, mobile phone, tablet, desktop computer, laptop computer, or other device capable to facilitating the present invention.

It should also be noted that the user device(s) 40 and/or input device(s) 30 may download and/or install an application 50, for example, from a mobile app store, which facilitates the implementation of the present invention, as described herein.

Furthermore, the network 15, as used herein, may include virtually any communication network or collection of networks capable of facilitating the practice of the present invention in the intended manner, such as, but not limited to, the World Wide Web or Internet, telecommunication networks (3G, 4G, LTE), Intranet, private or personal area networks, wide area networks, Bluetooth, Near-Field Communication (NFC), etc.

This written description provides an illustrative explanation and/or account of the present invention. It may be possible to deliver equivalent benefits and insights using variations of the sequence, steps, specific embodiments and methods, without departing from the inventive concept. This description and these drawings, therefore, are to be regarded as illustrative and not restrictive.

Now that the invention has been described,

What is claimed is:

1. A method, on at least one processing device, for publishing details of at least one sporting event, the processing device comprising a processor, memory and a data storage device, the method comprising:
receiving event data corresponding to the sporting event, in real-time during the course of the sporting event, the event data being received from an input device operated by an authorized user,
providing social interaction capabilities between a plurality of users, the social interaction capabilities comprising a selected exchange of media between the plurality of users via the at least one processing device,
processing a request to receive event data corresponding to a selected sporting event, the request being associated with at least one user account managed by the at least one processing device, and
communicating the event data corresponding to the selected sporting event to the corresponding user account.

2. The method as recited in claim 1 further comprising defining the input device as including a data input device operated by a sporting official officiating the sporting event.

3. The method as recited in claim 2 further comprising defining the event data as including a score of the sporting event and player misconduct occurring during the sporting event.

4. The method as recited in claim 3 further comprising defining the event data as including player substitution information during the sporting event.

5. The method as recited in claim 1 further comprising defining the input device as including a data input device operated by a single assigned administrator associated with at least one of the teams participating in the sporting event.

6. The method as recited in claim 1 wherein communicating the event data corresponding to the selected sporting event to the corresponding user account comprises generating push notifications to a user device associated with the user account.

7. The method as recited in claim 1 wherein communicating the event data corresponding to the selected sporting event to the corresponding user account comprises publishing the event data to a scrolling display, wherein the event data automatically scrolls across a user display screen.

8. The method as recited in claim 7 further comprising displaying the event data on the scrolling display in a user selected order.

9. The method as recited in claim 7 further comprising at least initially scrolling the event data via the scrolling display on the user display screen at a predetermined speed without user interaction.

10. The method as recited in claim 9 further comprising adjusting the scrolling speed of the scrolling display according to user interaction.

11. The method as recited in claim 9 further comprising adjusting the scrolling direction of the scrolling display according to user interaction.

12. A method, on at least one processing device, for publishing details of at least one sporting event, the processing device comprising a processor, memory and a data storage device, the method comprising:
receiving event data corresponding to the sporting event at the at least one processing device, in real-time during the course of the sporting event, the event data being received from an input device operated by a sporting official officiating the sporting event, the event data being representative of a score of the sporting event and player misconduct occurring during the course of the sporting event,
processing a request to receive event data, the request being associated with at least one user account managed by the at least one processing device, and
communicating the event data to the corresponding user account.

13. The method as recited in claim 12 further comprising providing social interaction capabilities between a plurality of users via the at least one processing device, the social interaction capabilities comprising a selected exchange of media between the plurality of users via the at least one processing device.

14. The method as recited in claim 12 further comprising defining the event data as including player substitution information during the sporting event.

15. The method as recited in claim 12 wherein communicating the event data corresponding to the selected sporting event to the corresponding user account comprises generating push notifications to a user device associated with the user account.

16. The method as recited in claim 12 wherein communicating the event data corresponding to the selected sporting event to the corresponding user account comprises publishing the event data to a scrolling display, wherein the event data automatically scrolls across a user display screen.

17. A method, on at least one processing device, for publishing details of at least one sporting event, the processing device comprising a processor, memory and a data storage device, the method comprising:
receiving event data corresponding to the sporting event at the at least one processing device, in real-time during the course of the sporting event, the event data being received from an input device operated by an authorized user,
processing a request to receive event data, the request being associated with at least one user account managed by the at least one processing device, and
publishing the event data to a scrolling display corresponding to the user account, wherein the event data automatically scrolls across a user display screen.

18. The method as recited in claim 17 further comprising displaying the event data on the scrolling display in a user selected order and at a predetermined speed without user interaction.

19. The method as recited in claim 18 further comprising defining the input device as including a data input device operated by a sporting official officiating the sporting event.

20. The method as recited in claim 19 further comprising defining the event data as including a score of the sporting event, player misconduct occurring during the sporting event and player substitution information during the sporting event.
